(19) United States
(12) Patent Application Publication
(10) Pub. No.: US 2003/0204738 A1
(43) Pub. Date: Oct. 30, 2003

(54) System and method for secure distribution of digital content via a network

(76) Inventor: Stephen Paul Morgan, (US)

Correspondence Address: Marc D. McSwain, C4TA/J2B, IBM ALMADEN RESEARCH CENTER, 650 HARRY ROAD, San Jose, CA, 95120-6099, US

(21) Appl. No.: 10/136,828

(22) Filed: Apr. 30, 2002

(51) Int. Cl. H04L 9/00

(52) U.S. Cl. 713/194

(57) ABSTRACT

The invention defines a system and method for broadcasting high quality, digitally encoded music and/or video (hereinafter called “content”) such that the content, once received, cannot be further redistributed in digital form. The content may be played as received on a receiving means (hereinafter called a “receiver”) or may be recorded digitally for later play-back on the same receiver. In one embodiment incorporating transportable ‘smart tokens’, the content may later be played back on a different receiver. The invention is directed primarily to preventing the piracy of content broadcast in support of services such as digital radio or television. In one preferred embodiment the invention may also be used to prevent piracy in the retail distribution of digital content.

### FIELD OF THE INVENTION

The invention relates to the field of secure distribution of digital content via a communications network, or more specifically to the secure distribution of streaming video and audio via the Internet.

### BACKGROUND OF THE INVENTION

The recent availability of high-quality digital means for storing and retrieving digital content has lead to its piracy by certain unscrupulous individuals and entities. Before the availability of such means, analog means typically were employed, and these means typically resulted in poor quality copies, especially when amateur-grade analog equipment was used and when it was used to create multiple generations of (analog) copies.

The advent of large scale, high performance and inexpensive distribution means such as the Internet and, in particular, the availability of World Wide Web services such as Napster and Gnutella has lead some to claim that these means encourage piracy of content. The content creation and distribution industries are at present fighting such piracy by attacking such services using legal means; however, as the cost to establish such services is very low, it seems unlikely that such piracy can be contained by legal means alone.

Previous attempts to solve these problems have included apparatus such as illustrated in the PRIOR ART figure (FIG. 1A) that use a data key to encrypt digital content data before distribution. The following US Patents describe apparatus, systems, and methods also used to solve some of these problems.

U.S. Pat. No. 5,669,370 (Kaniwa, et al.), teaches an information recording and reproduction apparatus to be controlled by temporal information. A main information signal comprising a content signal and a deadline signal is broadcast to a receiving means. A temporal information signal is acquired by the receiving means and is compared with the deadline signal. The content signal is cut off if an attempt is made to play the content after the deadline has passed. The security of Kaniwa may be compromised in several different ways. First, the content signal is transmitted in the clear, so the content may be played back via a receiving means not conforming to the invention. Second, the deadline signal is transmitted in the clear, so it may be modified to prevent signal cut-off. Third, the cut-off means is not necessarily tamper resistant, so it may be bypassed. Additionally, Kaniwa does not provide a means or method to record the content signal in a secure manner; thus, the content: (a) may be recorded and played back ad infinitum; (b) may be recorded and played back until the deadline; or (c) may not be recorded.

U.S. Pat. No. 6,055,314 (Spies, et al.) teaches a system and method for secure purchase and delivery of video content programs. Spies includes an integrated circuit card capable of decrypting content. When content is purchased, e.g., at a store, the key for the content is downloaded to the card. The content is accessed in encrypted format and is decrypted by the card using the key. Spies does not teach a means or method to limit the time window during which the content may be played back nor does it prevent the content from being copied once it has been decrypted.

The following are considered descriptive of the state of the art, but none teaches an apparatus, system or method that limits the time window during which content may be accessed: U.S. Pat. Nos. 5,191,611 (Lang), 6,049,789 (Frison, et al.), 5,959,945 (Kleiman), 5,892,825 (Mages, et al.), 5,889,860 (Eller, et al.), 5,812,663 (Akiyama, et al.), 5,636,276 (Brugger), 5,208,665 (McCalley, et al.), 4,991,207 (Shiraishi, et al.), 4,789,863 (Bush), 4,790,010 (Sgrignoli), and 4,710,921 (Ishidoh, et al.).

### SUMMARY OF THE INVENTION

The present invention instead addresses the elimination of such piracy via technical means, enabling content to be broadcast securely, i.e., such that it cannot be redistributed in digital form. In addition, a first generation digital copy of the content can be stored and later retrieved digitally by its legal recipient(s), but the content cannot be further redistributed in digital form.

The invention defines a system and method for broadcasting high quality, digitally encoded music and/or video (hereinafter called “content”) such that the content may be played as received on a receiving means (hereinafter called a “receiver”) or may be recorded digitally for later play-back on the same receiver. In a specific embodiment incorporating a transportable ‘smart token’, the content can later be played back on a second receiver. In this embodiment, the smart token and a removable storage medium are both transferred from the initial receiver to the second receiver, e.g., a car stereo. The invention is directed primarily to preventing the piracy of content broadcast in support of services such as digital radio or television. In one preferred embodiment the invention may also be used to prevent piracy in the retail distribution of digital content.

A specific embodiment of the invention includes an input digital content stream, a transmitter, an optional transmission-end storage and retrieval device controlled by the transmitter, a communications network connection, a tamper-resistant receiver, an optional receiver-end storage and retrieval device controlled by the receiver, and an output analog content stream.

The transmitter includes a connection with any communications network commonly used to retrieve and/or distribute digital information, such as a public switched telephone network, a local or wide area network, an intranet or internet, a broadcast television or radio network, a cable or satellite network or other traditional or nontraditional means including, by way of example, a kiosk in a retail music or video store, from which digital content may be retrieved.

The receiver implements certain well known public and secret key cryptography via a hardware decoding and digital-to-analog conversion device implemented monolithically using, preferably, tamper-resistant hardware. In more detail, the receiver includes a hardware decryption engine, an unforgeable real-time clock and one or more digital-to-analog converters (hereinafter called “DACs”), preferably one per content “channel”. For example, two DACs would be used for stereo music distribution, i.e., one for each audio channel, whereas five or more DACs would be needed for the five or more channels of “surround” sound often used in home theatres.

In a specific embodiment of the invention, a distribution session begins with the transmitter generating a secret session key and reading the current time (called the “distribution time”) from the transmitter's real time clock.

The transmitter then encrypts, using a public key and an agreed upon public key cryptographic algorithm such as Rivest-Shamir-Adelman (RSA), the session key, the distribution time and a symmetric key cryptographic algorithm selector. In another specific embodiment, the public key is shared among multiple transmitters rather than being unique to a given transmitter.

Next, the transmitter packs the result of the encryption operation along with a “handle” that uniquely identifies the public key, into a session establishment message.

The transmitter then sends the session establishment message to one or more simultaneously operating receivers via the communications network connection.

Upon reception of the session establishment message, each receiver extracts from the message the encrypted session key, the encrypted distribution time, the encrypted symmetric key cryptographic algorithm selector and the unencrypted handle.

Next, the receiver selects from its library of private keys, using the handle as a lookup means, the private key that corresponds cryptographically to the public key. In a specific embodiment, the private key is shared among multiple receivers, while in another specific embodiment, the private key is unique to a receiver.

The receiver then decrypts, by applying the private key and the agreed-upon public key cryptographic algorithm to the encrypted session key, the encrypted distribution time and the symmetric key cryptographic algorithm selector, respectively.

If the distribution time matches the current time per the receiver's real time clock, within certain bounds established to account for skew between the clocks of the transmission means and the reception means, as well as to account for the time necessary to distribute the contents, the receiver allows the distribution session; otherwise, it does not.

During a distribution session proper, the transmitter encrypts the digital content using the combination of the session key and the distribution time and the symmetric key cryptographic algorithm indicated by the symmetric key cryptographic algorithm selector, and distributes the result via the communications network connection to all connected receivers.

A receiver, having allowed the session, decrypts the content using the combination of the session key and the distribution time and the symmetric key cryptographic algorithm indicated by the symmetric key cryptographic algorithm selector, per the session establishment message.

As it receives the content or at some later time within the limit established by the distribution time, the reception means optionally may encrypt the digital content using, preferably, a symmetric key and a symmetric key cryptographic algorithm of its choice, and may save the result using a storage and retrieval means. To do so, the receiver encrypts the symmetric key using a public key unique to the reception means and a corresponding public key encryption algorithm, and saves the result using the storage and retrieval means. The receiver then encrypts the content using the symmetric key and the symmetric key cryptographic algorithm and saves the result using the storage and retrieval means.

To later retrieve the content from the storage and retrieval means, the reception means first retrieves the encrypted symmetric key from the storage and retrieval means, then decrypts the symmetric key using a private key corresponding to the public key and the public key encryption algorithm that were used to encrypt the symmetric key. The private key is assumed to be unique to the reception means. As such, no other reception means can decrypt the symmetric key.

Next, the receiver retrieves the content from the storage and retrieval means and uses the symmetric key and the symmetric key cryptographic algorithm to decrypt it. Finally, the decrypted digital content is converted for analog output.

### BRIEF SUMMARY OF THE DRAWINGS

FIG. 1A is a prior art apparatus for protecting digital content.

FIG. 1B is a block diagram that illustrates a system for the secure distribution of digital content according to one aspect of the present invention.

FIG. 2 is a partial block diagram that illustrates the security enclosure of FIG. 1B including multiple private keys.

FIG. 3 is a partial block diagram that illustrates the security enclosure of FIG. 1B including decryption algorithm selection.

FIG. 4A is a pictorial diagram that illustrates control information including a clear handle for selecting a specific private key.

FIG. 4B is a pictorial diagram showing control information presented as a header preceding an encrypted digital content stream.

FIG. 5 is a partial block diagram that illustrates optional storage and retrieval of a digital content stream at a receiver end.

FIG. 6 is a block diagram that illustrates details of a transmitter according to another aspect of the present invention.

FIG. 7 is a simplified block diagram showing a specific embodiment of a transmitter according to another aspect of the invention.

FIG. 8 is a simplified block diagram illustrating another specific embodiment of a transmitter.

FIG. 9 is a partial block diagram showing part of the system of FIG. 1B including a transmitter for providing an encrypted digital content stream.

FIG. 10 is a partial block diagram that illustrates the transmitter of FIG. 9 including an optional storage retrieval media for the digital content stream.

FIG. 11 is a pictorial diagram that illustrates a specific time code format.

FIG. 12 is a pictorial diagram that illustrates a preferred time code format.

FIG. 13 is a block diagram showing an apparatus for comparing a local real time with a received time code for enabling decryption, conversion, and output of a received encrypted digital content stream.

FIG. 14 is a process flow diagram for a method for securing distributing digital content via a communications network.

FIG. 15 is a partial process flow diagram adding stored private keys to the process of FIG. 14.

FIG. 16 is a partial process flow diagram adding selectable decryption algorithms to the process of FIG. 14.

FIG. 17 is a partial process flow diagram placing control information of FIG. 14 as a header preceding the digital content stream.

FIG. 18 is a partial process flow diagram adding protected storage and reuse of the received digital content stream.

FIG. 19 is a partial process flow diagram defining a transmitter function for the method of FIG. 14.

FIG. 20 is a partial process flow diagram including the transmitter function selecting an encryption algorithm.

FIG. 21 is a partial process flow diagram adding storage and reuse of the digital content stream at the transmitter end.

FIG. 22 is a partial process flow diagram describing a method for determining whether receiver end real time is within a defined window-of-opportunity.

FIG. 23 is a block diagram showing a useful combination product of the present invention.

FIG. 24 is a system level diagram of a specific embodiment of a system for the secure distribution of digital content via a communications network.

FIG. 25 is a detailed block diagram of a specific embodiment of a receiver for use in the system of FIG. 24.

### DETAILED DESCRIPTION OF THE INVENTION

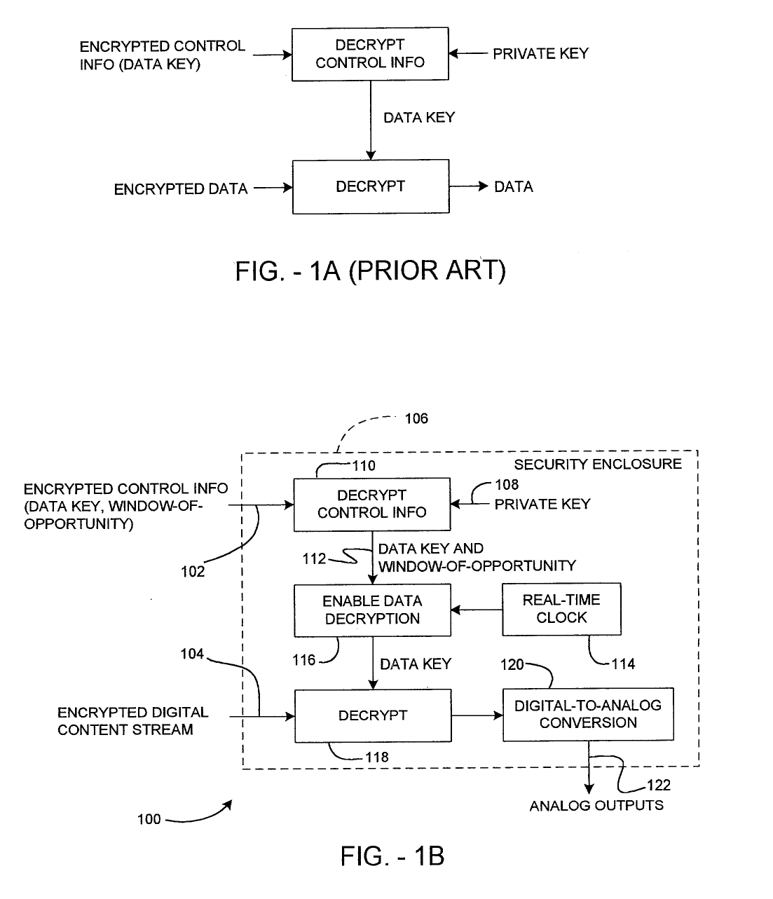

With reference to FIG. 1B there is shown a system for the secure distribution of digital content according to a specific embodiment of the present invention. The system is designated generally by the reference numeral 100 and includes encrypted control information 102, an encrypted digital content stream 104, a tamper-resistant security enclosure 106, a private key 108, a circuit 110 for decrypting the encrypted control information to obtain 112 a data key and a time code defining a window-of-opportunity, a local real time clock 114, a circuit 116 for comparing an output of the local real time clock with the window-of-opportunity for enabling decryption of the encrypted digital content stream, a decryption circuit 118 for using the data key to decrypt the encrypted digital content stream when enabled by the circuit 116, a digital-to-analog conversion circuit 120 for converting the decrypted digital content stream to analog content, and analog outputs 122 for providing the analog equivalent of the digital content stream outside the security enclosure 106.

FIG. 1B illustrates the invention in its simplest form. In a specific embodiment, the tamper-resistant security enclosure 106 is a single integrated circuit located within a computer platform having a connection with a communications network such as the Internet. The encrypted digital content stream 104 represents a streaming video/audio presentation, encrypted to prevent use by unauthorized users. The encrypted control information 102 includes a data key necessary to decrypt the streaming video/audio presentation. The present invention differs however from a similar arrangement illustrated in the PRIOR ART figure in at least several respects. The first of these is that the encrypted control information includes a time code that defines an interval during which the data key to will be valid for decrypting streaming video/audio presentation—hence the reference to a “window-of-opportunity.” The tamper-resistant security enclosure 106 includes a real-time clock 114 that is compared with the time code to determine whether the current local real time is within the window-of-opportunity. Decryption of the encrypted streaming video/audio presentation is enabled when the local real time is within the defined window. Another feature of the invention is that conversion to an analog output stream 122 is handled within the tamper-resistant security enclosure 106. Thus the digital content stream is never available in unencrypted (“clear”) form outside the tamper-resistant enclosure 106. The data key, necessary to decrypt the digital content stream 104, is part of the encrypted control information 102. Thus the necessary data key can only be obtained in useable form by use of the private key 108 available only within the security enclosure 106. The streaming digital/audio presentation arrives in encrypted form 104, enters the security enclosure 106, and leaves in analog form 122.

The general principles of operation of the system 100 are as follows. A trusted entity (not shown) distributes the data key and time code encrypted using a public key that corresponds with the private key 108. This information arrives, typically via the communications network (not shown) and is directed to the security enclosure 106 as the encrypted control information 102. The private key 108 is used by the circuit 110 to decrypt the received control information and to obtain clear versions 112 of the data key and the time code. The time code is compared with an output of the local real time clock 114 by the comparison circuit 116, and decryption of the streaming video/audio presentation is enabled when the local time is within the defined window-of-opportunity. The encrypted digital content stream 104 is also typically received via the communication network following an opportunity to make the time code comparison. The decrypted data key is used by the circuit 118 to decrypt the streaming video/audio presentation, and the decrypted digital stream is converted to analog outputs 122 by the circuit 120. The typical analog outputs are suitable for connection to a display monitor and audio reproduction system, or alternatively to a standard television receiver. Attempts to tamper with the security enclosure result in its destruction so that the tamper-resistant feature cannot be readily defeated. Though the analog outputs can be recorded and distributed or reused without limit, the music and video industries are not so concerned as they are about the use of unauthorized high-quality digital versions of the streaming presentation.

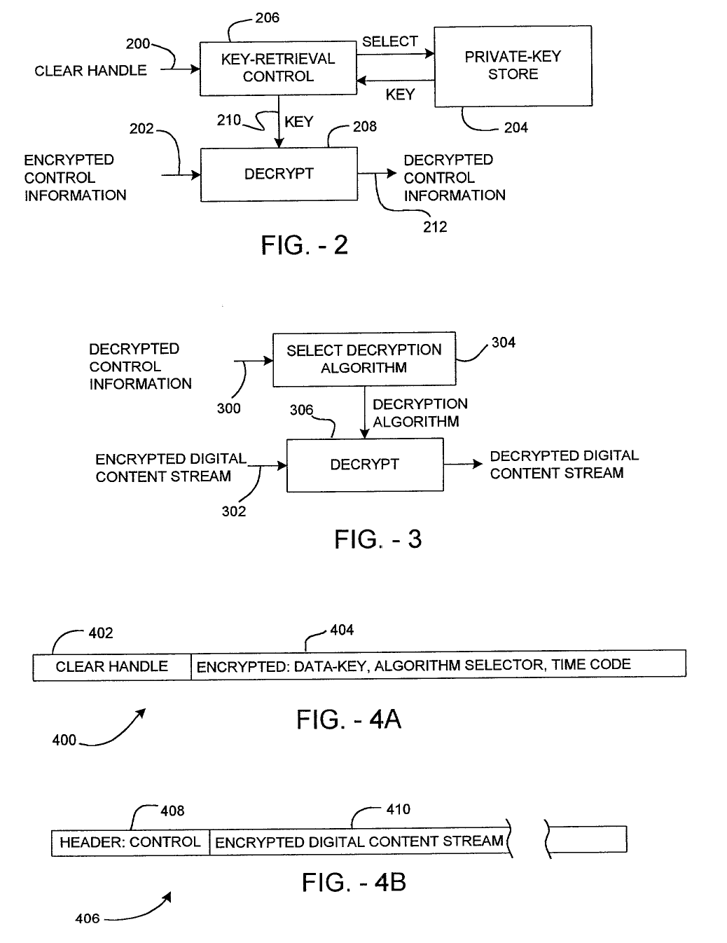

FIG. 2 is a partial block diagram that illustrates the use of a “handle” transmitted in the clear that identifies the use of a specific private key for decrypting the encrypted control information shown in FIG. 1B. FIG. 2 includes a clear handle 200, encrypted control information 202, a private-key storage and retrieval element containing a plurality of private keys 204, a key-retrieval control circuit 206, and a circuit 208 for using a selected private key 210 for decrypting the encrypted control information. The elements 204, 206, 208, 210 are all contained within a tamper-resistant security enclosure such as enclosure 106 of FIG. 1B. In a specific embodiment of the invention, the private-key storage and retrieval element 204 is implemented using non-volatile memory, such as flash memory. In another specific embodiment of the invention, the plurality of private keys are stored into the storage/retrieval element 204 by a trusted entity at the time the security enclosure is manufactured. In practice, the clear handle 200 is distributed ahead of the encrypted control information 202 (data key and time code) to permit time to select and retrieve a private key 210 identified by the handle. The circuit 206 receives the clear handle and uses it to select a specific private key from the private-key storage and retrieval element 204. The selected key 210 is then used by the circuit 208 to decrypt the encrypted control information 202 and to obtain decrypted control information 212 such as the data key and time code of FIG. 1B. In a typical application, the clear handle is distributed by the entity that distributes the encrypted control information, and is concatenated with the encrypted control information to form a separate control header that precedes the encrypted digital content stream during distribution via a communications network such as the Internet (not shown).

Another specific embodiment of the invention is illustrated in FIG. 3, a partial block diagram having elements located within a tamper-resistant security enclosure such as enclosure 106 of FIG. 1B. FIG. 3 includes decrypted control information 300, an encrypted digital content stream 302, a circuit 304 responsive to a portion of the decrypted control information for selecting a specific decryption algorithm for use in decrypting the received encrypted digital content stream 302, and a decryption circuit 306 that implements the decryption algorithms selectable by the circuit 304. In practice, the encrypted control information includes a code for selecting a specific digital content stream decryption algorithm. The decryption algorithm corresponds to the encryption algorithm used to encrypt the digital content stream 302. In a specific embodiment of the invention, the digital content stream is encrypted using a symmetric key encryption algorithm and a copy of the data key used to encrypt the digital content stream is provided as part of the encrypted control information (102 of FIG. 1B). Alternative encryption algorithms are available to the entity that encrypts the digital content stream. The encrypting entity provides a code that identifies the algorithm used, and supplies the code and the data key used for encryption. The provided code and data key are combined with an appropriate time code, are encrypted using a public key, and the result is distributed as the encrypted control information. The received encrypted control information (102 of FIG. 1B) is decrypted 300 and then the circuit 304 uses the code portion to select a corresponding decryption algorithm for the encrypted digital content stream 302. In this specific embodiment, the circuit 306 implements a variety of selectable decryption algorithms, and is responsive to the code portion for using the intended algorithm to decrypt the received digital content stream 302.

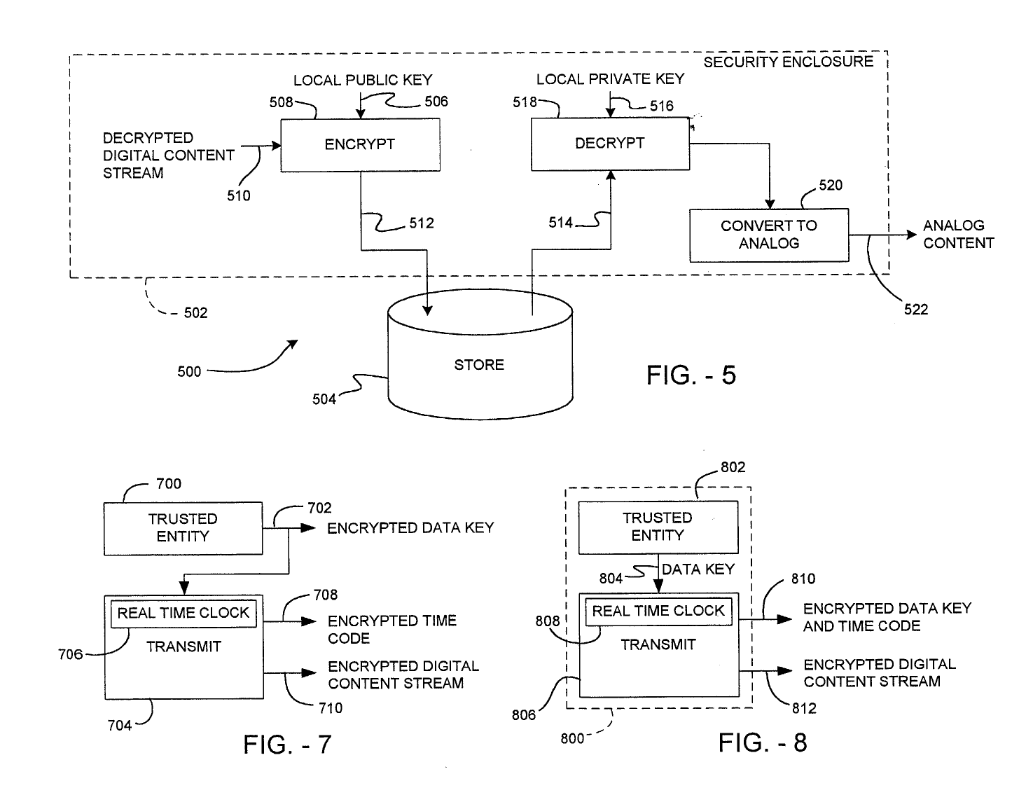

In another specific embodiment of the invention, the encrypted control information defines a “session establishment message” used to provide the data key, to define a window-of-opportunity, and to select a specific decryption algorithm. In another specific embodiment, the session establishment message includes the clear “handle” (200 of FIG. 2) used to specify a private key for the decryption of the encrypted portion of the message. Such a message format is illustrated in FIG. 4A. The session establishment message is designated generally by the reference numeral 400, and includes the clear handle portion 402 and an encrypted portion 404 containing the data key, the algorithm selection code, and the time code.

In another specific embodiment of the invention, the session establishment message 400 is concatenated to the front end of the encrypted digital content stream to form a composite distributed entity 406. The distributed entity 406 includes a control header 408 and the concatenated encrypted digital content stream 410. In a specific embodiment, the control header 408 includes the information illustrated in FIG. 4A.

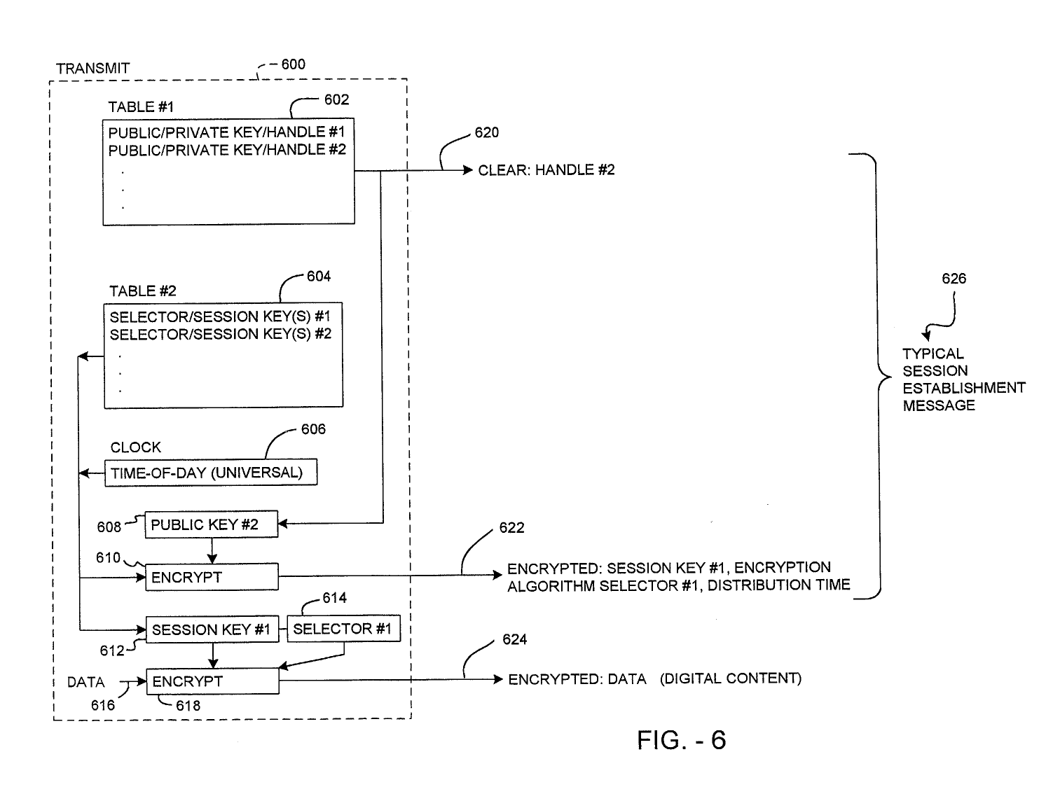

FIG. 5 is a partial block diagram that illustrates another specific embodiment of the invention permitting storage and retrieval of the received digital content stream for later reuse. Added elements of the embodiment are designated generally by the numeral 500 and include a tamper-resistant security enclosure 502, a digital store 504, a local public key 506, a re-encryption circuit 508, a decrypted digital content stream 510, a re-encrypted digital content stream 512, a retrieved encrypted digital content stream 514, a local private key 516, a re-decryption circuit 518, a digital-to-analog conversion circuit 520, and analog content output 522.

The security enclosure 502 corresponds with security enclosure 106 of FIG. 1B. In general, this embodiment permits a user to store a locally encrypted copy of the digital content stream for later use. In a specific embodiment, the local public key 506 is placed into the security enclosure 502 by a trusted entity at time of manufacture and is unknown to the user. A decrypted digital content stream 510, available only within the security enclosure 502, is re-encrypted by the circuit 508 using the local public key 506. The re-encrypted stream 512 is stored on the digital store 504 for later reuse. Though in a specific embodiment the digital store 504 is located outside the security enclosure 502, the digital content stream stored thereon has been re-encrypted and is thus secure. The stored digital content stream is retrieved 514 and is re-decrypted by the circuit 518 using the local private key 516, which in general differs from the private key 108 of FIG. 1B used to decrypt the control information. The re-decrypted digital content stream is available only within the tamper-resistant security enclosure 502, and is converted to analog form before being output as analog content 522.

In one specific embodiment, the digital store 504 is a hard disk, but in another specific embodiment, the digital store 504 is an optical storage medium such as a CD or DVD or similar device, permitting the stored digital content stream to be played on another device so long as the other device contains a copy of the local private key 516. A person skilled in the appropriate arts will appreciate that other forms of digital storage can be substituted for the hard disk or the optical storage medium without deviating from the spirit of the invention. For example, in one specific embodiment (not shown) a removable digital storage medium is used as the digital store 504, permitting the user to transfer the stored digital content stream to another device for playing back. The only requirement for the other device is that it too include a security enclosure containing a copy of the local private key 516, the decryption circuit 518, and digital-to-analog conversion circuit 520, and providing analog content equivalent to 522.

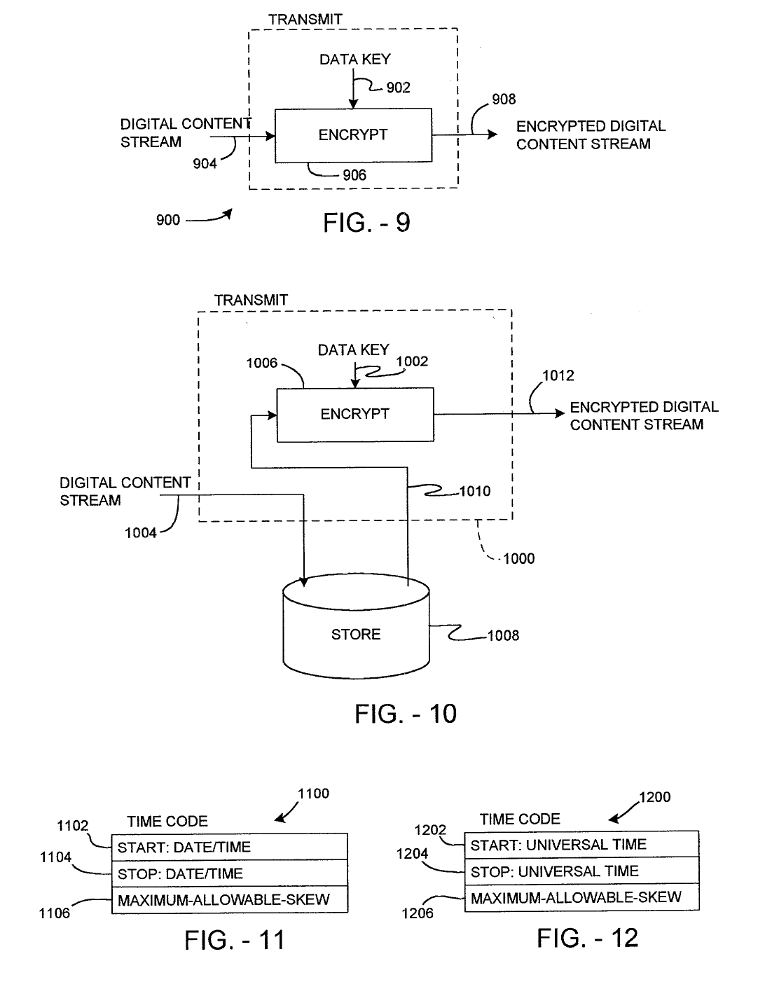

FIGS. 6, 7 and 8 shift the focus from the receiving side of the system to the transmitting side. FIG. 6 is a partial block diagram that illustrates details of a specific embodiment of such a transmitter, while FIGS. 7 and 8 are simplified block diagrams that present two alternative embodiments of the transmitter in less detail.

FIG. 6 illustrates an embodiment in which a transmitter (Broadcast) 600 includes all keys necessary to encrypt control information and a digital content stream as those terms have been used above with respect to other drawing figures. In general the transmitter 600 includes a first table 602 storing public/private key pairs with handles used to identify a specific pair, a second table 604 storing encryption algorithm selection codes and associated session keys, a transmitter real time clock 606, a selected public key 608, a circuit 610 for encrypting control information, a selected session key 612, and corresponding encryption algorithm selection code 614, a digital content stream 616, a circuit 618 responsive to the session key 612 and to the algorithm selector 614 for encrypting the digital content stream 616. The transmitter outputs a clear handle 620, encrypted control information 622, and an encrypted digital control stream 624. In a specific embodiment, the clear handle 620 and the encrypted control information 622 define a session establishment message 626.

The various parts of the session establishment message 626 have been previously described (see the description relating to FIGS. 2, 3, 4A, and 4B). FIG. 6 illustrates a specific embodiment that implements a transmitter for distributing both the session establishment message and the encrypted digital content stream and illustrates details that permit the transmitter 600 to accomplish its tasks.

The first table 602 stores public/private key pairs and corresponding clear handles. In another specific embodiment (not shown) the first table 602 stores only the public keys and corresponding clear handles. A selected public key from the first table 602 is used by the transmitter 600 to encrypt portions of the control information. The public keys correspond with private keys stored within the security enclosures of receivers (see 204 of FIG. 2), used by the receivers for decrypting the encrypted portions of the control information (202 of FIG. 2). The transmitter 600 includes means (not shown) for selecting a specific public key from the first table 602 and the corresponding clear handle 620. In a specific embodiment, the selected clear handle 620 is made a part of a session establishment message 626 and is distributed to intended receivers (not shown). The purpose of the clear handle 620 has been described with respect to FIG. 2, above.

The second table 604 stores encryption algorithm selectors and encryption data keys used to encrypt the digital content stream 616. In a specific embodiment, the transmitter 600 includes means (not shown) for selecting a specific algorithm selector and corresponding data key (session key). In another specific embodiment, the second table 604 stores encryption algorithm selectors and corresponding data keys, the algorithms using more than one data key according to well known symmetric encryption algorithms. The invention relates, in part, to the manner of using well known encryption algorithms. Disclosure of new encryption algorithms is not part of the present invention. Therefore a person having an ordinary level of skill in the related arts will have knowledge of various algorithms suitable for the intended purpose.

The transmitter 600 includes a real time clock 606 that provides current date and time information. An example is a Universal Time Code used by many manufacturers that specifies the number of elapsed seconds measured from midnight at the start of Jan. 1, 1980. In a specific embodiment, the output of the clock circuit 606 includes a start date/time, a stop date/time (both expressed in the Universal Time Code), and a number representing a maximum-allowable-skew expressed also in Universal Time increments. As an example of a maximum-allowable-skew, some of the receiver clocks may have been set at time of manufacture three years before the present time. In general, the receiver clocks will not track the transmitter clocks precisely, but can be manufactured to remain within a predetermined range of “skew” of the transmitter clocks. If the maximum skew expected is plus-or-minus one minute per year, then the three-year-old receiver clocks will, at most be plus-or-minus three minutes of the transmitter time. Thus a window-of-opportunity defined by a transmitted start time of 10AM and stop time of NOON, will extend at a receiver from 9:57AM to 12:03PM.

The selected public key 608 is used by the circuit 610 to encrypt portions of the control information including the selected digital content stream encryption algorithm selector and data keys (session keys), and the time code (referred to in FIG. 6 as the “distribution time” and referred to elsewhere as a start date/time, a stop date/time, and a maximum-allowable-skew) 622. In a specific embodiment, the clear handle 620 and the encrypted control information 622 are transmitted together as a session establishment message 626.

The selected session key 612 and encryption algorithm selector 614 are used by the circuit 618 to implement a specific encryption algorithm for encrypting the digital content stream 616. The encrypted stream 624 is distributed to intended receivers.

FIG. 7 illustrates an embodiment in which a trusted entity, independently of the transmitter, provides an encrypted data key for use by the transmitter for encrypting a digital content stream, and by a receiver for decrypting a received encrypted digital content stream. FIG. 7 includes a trusted entity 700, an encrypted data key 702, a transmitter (Broadcast) 704, a transmitter real time clock 706, a transmitted encrypted time code 708, and a transmitted encrypted digital content stream 710. The transmitter real time clock 706 is used by the transmitter to obtain a time code that is used to define a window-of-opportunity during which the encrypted data key 702 is valid for decrypting the encrypted digital content stream 710. The time code is encrypted by the transmitter (not shown) and must be decrypted by a receiver using an appropriate key.

FIG. 8 illustrates an embodiment in which the trusted entity is contained within (alternatively, is under the control of) the transmitter. FIG. 8 includes a transmitting entity 800, a trusted entity 802, a data key 804, a transmitter (Broadcast) 806, a transmitter real time clock 808, a transmitted encrypted data key and time code 810, and a transmitted encrypted digital content stream 812. In this embodiment, the transmitter receives a data key 804 from the trusted entity 802, and uses the data key to encrypt and transmit the digital content stream 812. The transmitter 806 also combines the data key with a time code defining a window-or-opportunity, encrypts these and transmits the combination 810.

It will be appreciated that the transmissions are being made via a communications network (not shown), and that in a specific embodiment, the communications network is the Internet.

FIG. 9 is a partial block diagram that illustrates another specific embodiment of a transmitter designated generally by the reference numeral 900. The transmitter 900 includes a data key 902, a received digital content stream 904, a circuit 906 for encrypting the received digital content stream, and transmits an encrypted digital content stream 908. The transmitter 900 represents the simplest transmitter embodiment for providing an encrypted digital content stream according to one aspect of the invention.

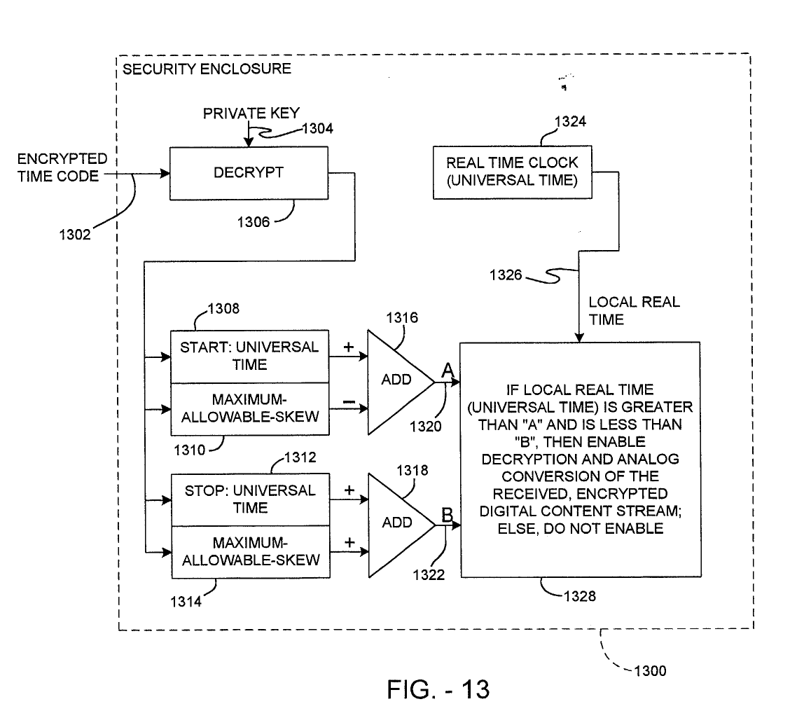

FIG. 10 is a partial block diagram illustrating a transmitter having a digital store for storing a received digital content stream. The transmitter is designated by the reference numeral 1000 and includes a data key 1002, a received digital content stream 1004, a circuit 1006 for encrypting a retrieved digital content stream, a digital storage/retrieval device 1008, and transmits an encrypted digital content stream 1012. In practice, the transmitter uses a storage/retrieval control circuit (not shown) to direct the received digital content stream 1004 to the digital storage/retrieval device 1008. In a specific embodiment of the invention, the storage/retrieval device 1008 is a hard disk. However, a person having an ordinary level of skill in the relevant arts will appreciate that other storage/retrieval devices can also be used for device 1008, for example, an optical storage device such as a CD or DVD. The transmitter 1000 uses the storage/retrieval control circuit (not shown) to retrieve a previously stored digital content stream 1010 and connect the retrieved stream to the encryption circuit 1006 for generating the transmitted encrypted digital content stream 1012.

FIGS. 11, 12, and 13 relate to the time code transmitted as part of the encrypted control information (102 of FIG. 1B). FIGS. 11 and 12 illustrate two alternative formats for the time code used to define a window-of-opportunity. Once again, in a specific embodiment, the window-of-opportunity defines an interval during which a data key provided as part of the encrypted control information (102 of FIG. 1B, 622 of FIG. 6) is valid for decrypting the encrypted digital content stream (104 of FIG. 1B, 624 of FIG. 6). FIG. 13 illustrates one embodiment for determining whether a local real time is within the defined window-of-opportunity.

FIG. 11 is a pictorial diagram that illustrates one format for a time code, designated generally by the numeral 1100. The time code 1100 includes a start date/time 1102, a stop date/time 1104, and a number 1106 representing a maximum-allowable-skew, as described previously with respect to FIG. 6.

FIG. 12 is a pictorial diagram that illustrates a preferred format for a time code, designated generally by the numeral 1200, and including a start date/time 1202 expressed using a Universal Time Code (see description with respect to FIG. 6), a stop date/time 1204 expressed using a Universal Time Code, and a number 1206 representing a maximum-allowable-skew.

FIG. 13 is a partial block diagram that illustrates a portion of a security enclosure designated by the numeral 1300. The security enclosure 1300 corresponds to the security enclosure 106 of FIG. 1B and includes a received encrypted time code 1302, a private key 1304, a decryption circuit 1306, storage registers 1308, 1310, 1312, and 1314, adders 1316 and 1318, a real time clock 1324, and a process 1328 for enabling/disabling the decryption of a received digital content stream.

In general, the time code is encrypted with additional information to form the encrypted control information (102 of FIG. 1B). FIG. 13 assumes that the time code is separately encrypted 1302. A person having an ordinary level of skill in the relevant arts will know how to obtain the decrypted time code from encrypted control information. The purpose of FIG. 13 is to illustrate the manner in which, in one embodiment of the invention, a local real time 1326 is compared with a received encrypted time code 1302 to determine whether to enable decryption of a received digital content stream. FIG. 13 is thus intentionally simplified to exclude unnecessary detail, and to focus on the central purpose.

The received encrypted time code 1302 is decrypted 1306 using the private key 1304 for that purpose. Decryption produces a start date/time expressed in a Universal Time Code and stored in register 1308 (hereafter referred to simply as the “start time” 1308), a stop date/time expressed in the Universal Time Code (“stop time” 1312), and a maximum-allowable-skew expressed in Universal Time Code increments (“skew” 1310, 1314).

The skew 1310 is subtracted from the start time 1308 (e.g., 10AM becomes 9:57AM) by the adder circuit 1316, and provides the difference “A” 1320. The skew 1314 is added to the stop time 1312 (e.g., NOON becomes 12:03PM) by the adder circuit 1318, and provides the sum “B” 1322.

The real time clock 1324 provides local real time 1326 expressed the in terms of the Universal Time Code for compatibility with the computed difference “A” and sum “B”. The process indicated by the box 1328 makes the following comparison and determination: if local real time 1326 is greater than “A” 1320, AND is less than “B” 1322, then enable the decryption, analog conversion and output of the received digital content stream, else do not enable. That is, if the local real time is greater than “A” and is less than “B”, then local real time is within the defined window-of-opportunity, and decryption, conversion and output of the analog content is enabled. If the local real time is not within the window-of-opportunity, such output is not enabled. In this manner the distributor of the decryption data key controls the use of the key. The distributor may, if he chooses, require a new key be used for later portions of the digital content stream.

FIGS. 14-22 are process flow diagrams that describe methods for the secure distribution of digital content via a communications network.

FIG. 14 describes a method for securely distributing a digital content stream via a communications network, the method designated by the reference numeral 1400 and includes steps 1402 through 1418. The method begins with step 1402 that provides encrypted control information including a data key and a time code defining a window-of-opportunity. A step 1404 provides an encrypted digital content stream via a communications network. A step 1406 provides a tamper-resistant environment that includes a private key and a local real time clock. The provided encrypted control information is received at step 1408, and is decrypted using the private key at step 1410. At step 1412 a local real time is compared with the decrypted time code to determine whether the local time is within the window-of-opportunity. The provided encrypted digital content stream is received at step 1414, and is decrypted using the decrypted data key at step 1416 when it has been determined that the local real time is within the window-of-opportunity. Finally, at step 1418 the decrypted digital content stream is converted to analog content for output. The method of FIG. 14 will be recognized as implementing the system illustrated in FIG. 1B.

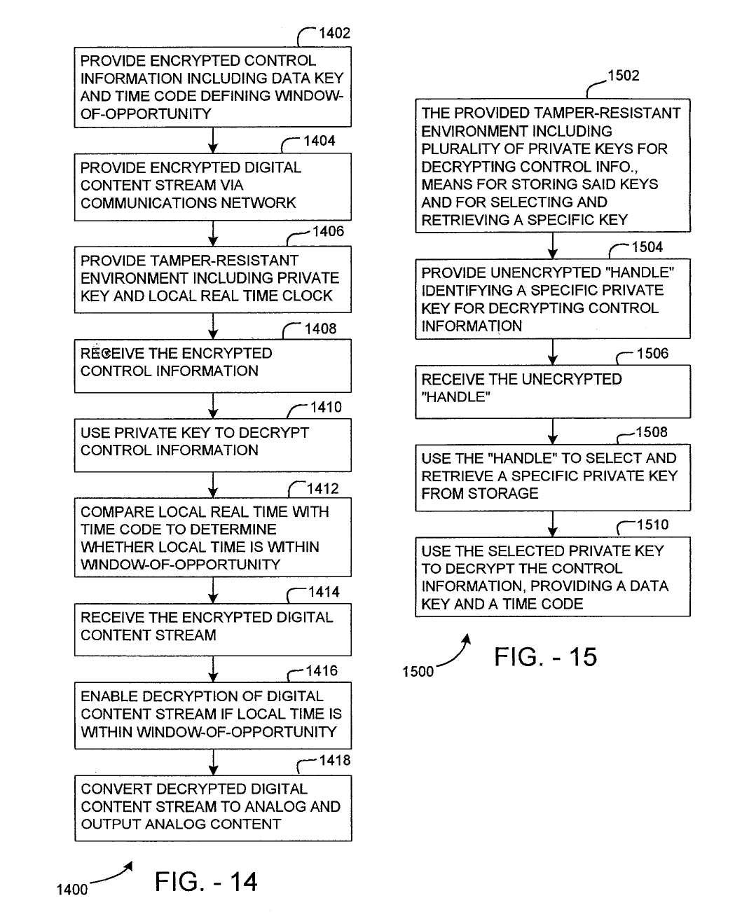

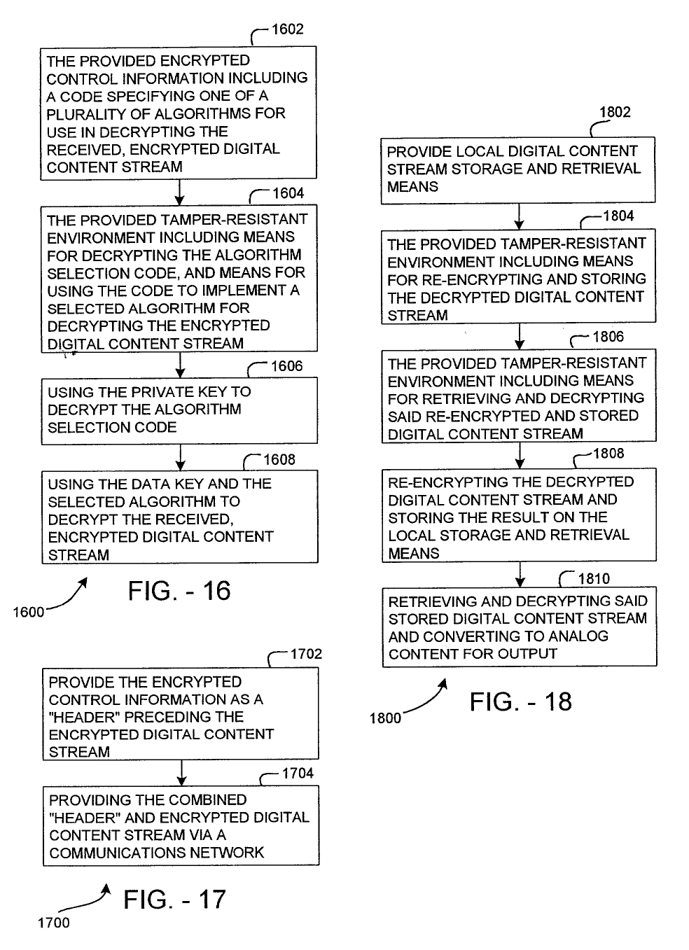

FIG. 15 further defines the provided tamper-resistant environment of the method of FIG. 14, adding the detail relating to the storage of multiple private keys within the tamper-resistant environment and the use of a clear handle to select a specific private key for decrypting the encrypted control information. A step 1502 adds a plurality of private keys and provides means for storing and retrieving the keys. A step 1504 provides an unencrypted (“clear”) handle used to identify a specific key for use in decrypting the encrypted information. The provided clear handle is received at step 1506, and at step 1508 is used to select and retrieve a specific private key from the provided key storage. At step 1510 the selected and retrieved private key is used to decrypt the encrypted control information (corresponding to step 1410 of FIG. 14).

FIG. 16 further defines the provided encrypted control information and the provided tamper-resistant environment of the method of FIG. 14, and adds selection of a specific encryption/decryption algorithm for the digital content stream. The method of FIG. 16 is designated generally by the numeral 1600 and includes steps 1602 through 1608. A step 1602 further modifies provided encrypted control information to include a code specifying one of a plurality of algorithms for use in decrypting the received, encrypted digital content stream. A step 1604 further modifies the provided tamper-resistant environment for supporting such algorithm selection. A step 1606 uses the private key to decrypt the algorithm selection code portion of the encrypted control information. Finally, a step 1608 uses the decrypted data key and the selected algorithm to decrypt the received, encrypted digital content stream.

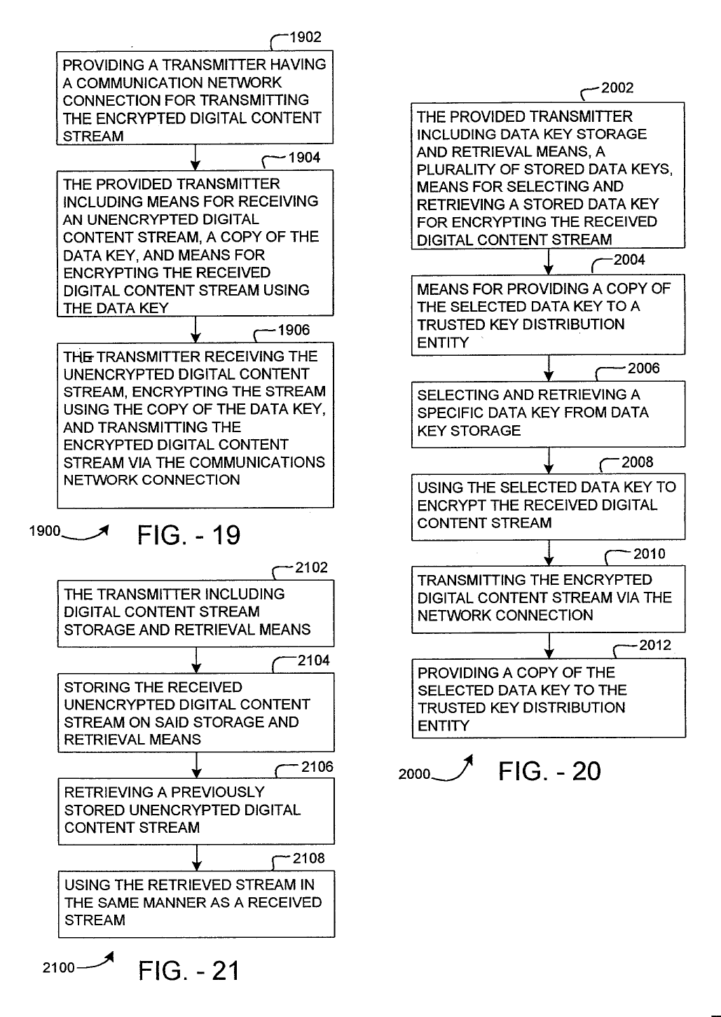

FIG. 17 further defines the provided encrypted control information (numeral 1700, generally) of the method of FIG. 14 by including the encrypted control information as a “header” preceding the encrypted digital content stream (step 1702). A step 1704 provides the combined control header and digital content stream via the communications network.

FIG. 18 further defines the method of FIG. 14 by providing local storage for the received digital content stream. The method of FIG. 18 is designated generally by the reference numeral 1800 and includes steps 1802 through 1810. A step 1802 provides a local digital content stream storage and retrieval device (504 of FIG. 5). A step 1804 further modifies the provided tamper-resistant environment by including a circuit for re-encrypting and storing the decrypted digital content stream (512 of FIG. 5). A step 1806 modifies the provided tamper resistant environment by including a circuit for retrieving and decrypting the previously re-encrypted and stored digital content stream. A step 1808 uses the modified tamper-resistant environment (security enclosure 502 of FIG. 5) to re-encrypt and store the decrypted digital content stream on the provided local storage and retrieval device. Finally, a step 1810 retrieves and decrypts a previously re-encrypted and stored digital content stream and converts the stream to analog content for output.

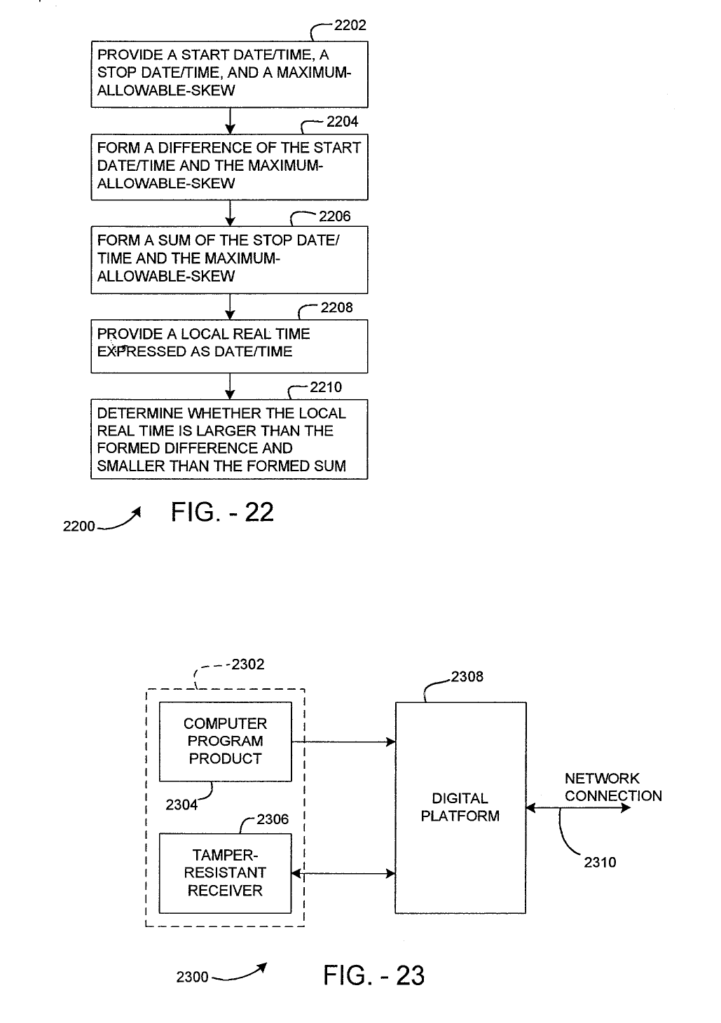

FIG. 19 defines another modification of the method of FIG. 14 by defining a transmitter for distributing the encrypted digital content stream via a communications network. The method of FIG. 19 is designated generally by the numeral 1900 and includes steps 1902 through 1906. A step 1902 provides a transmitter having a communication network connection for transmitting the encrypted digital content stream. A step 1904 further provides the transmitter with a connection for receiving an unencrypted digital content stream, a copy of the data key, and a circuit that uses the data key for encrypting the unencrypted digital content stream. Finally, a step 1906 uses the provided transmitter to receive the unencrypted digital content stream and the data key, and uses the provided circuit and the data key to encrypt the digital content stream, and then uses the network connection for transmitting the encrypted digital content stream.

FIG. 20 defines a further modification of the method of FIG. 19 by providing data key storage, a plurality of data keys, and a process step for providing a copy of a selected data key to a trusted key distribution entity. It will be appreciated by persons having an ordinary level of skill in the relevant arts that key selection and distribution often is the responsibility of an independent trusted entity (a key escrow). FIG. 20 defines a method that departs from that usual manner of operation. The key selection choice resides within the provided transmitter, and a copy of the selected key is used to encrypt the digital content stream, and is also provided by the transmitter to the independent trusted entity. The method of FIG. 20 is designated in general by the numeral 2000 and includes steps 2002 through 2012. A step 2002 modifies the provided transmitter by adding a plurality of data keys, a device for storing the keys, and a circuit for selecting and retrieving a specific data key. A step 2004 defines a process for providing a copy of the selected key to a trusted key distribution entity. A step 2006 implements selecting and retrieving a specific key form storage. A step 2008 uses the selected key to encrypt the received digital content stream. A step 2010 transmits the encrypted digital content stream via the network connection. Finally, a step 2012 provides a copy of the selected data key to the trusted key distribution entity.

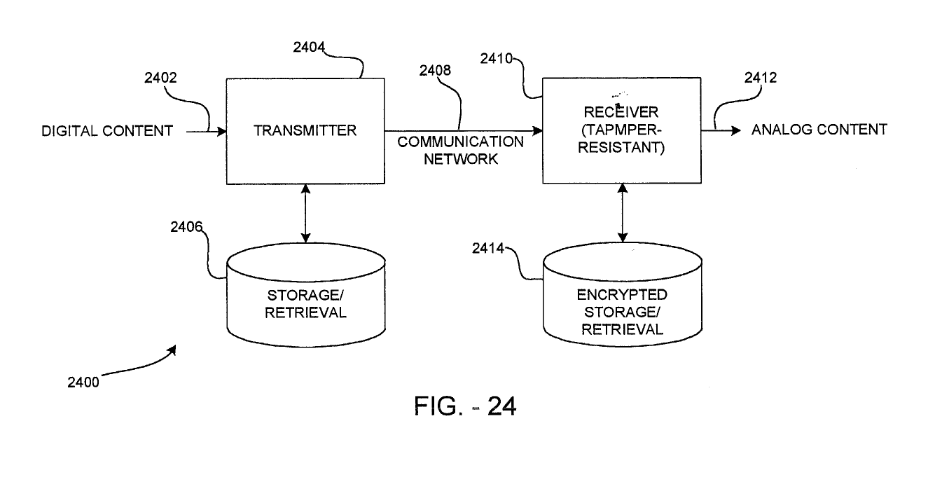

FIG. 21 defines a further modification of the method of FIG. 19 by modifying the provided transmitter with access to a digital content stream storage device (1008 of FIG. 10). The method of FIG. 21 is designated generally by the numeral 2100 and includes steps 2102 through 2108. A step 2102 modifies the provided transmitter by adding a digital content stream storage and retrieval device. A step 2104 uses the added storage device to store a received unencrypted digital content stream. A step 2106 retrieves a previously stored digital content stream, and a final step 2108 uses the retrieved stream in the same manner as a received stream is used in the method of FIG. 19, i.e., the stream is encrypted and transmitted via the network connection.

FIG. 22 defines a further modification of the method of FIG. 14 by providing time code information that defines a window of opportunity in a specific manner. The method of FG. 22 is designated generally by the numeral 2200 and includes steps 2202 through 2210 (see also FIGS. 11, 12, and 13). A step 2202 provides a start date/time, a stop date/time, and a number representing a maximum-allowable-skew. A step 2204 forms a difference by subtracting the number representing the maximum-allowable-skew from the start date/time. It will be understood by those having an ordinary level of skill in the relevant arts that the start date/time and the number representing the maximum-allowable-skew are expressed in compatible units, e.g. both being expressed in terms of a Universal Time Code as discussed above with respect to FIGS. 11, 12, and 13. Next, a step 2206 forms a sum by adding the stop date/time and the number representing the maximum-allowable-skew. A step 2208 provides a local real time expressed in compatible units such as a Universal Time Code. Finally, a step 2210 determines whether the provided local real time is larger than the formed difference and is smaller than the formed sum. When the local real time satisfies those two requirements, the local real time is said to be within the window-of-opportunity during which the provided data key is valid for decrypting the encrypted digital content stream.

Another specific embodiment of the invention defines a computer program product storing a method executable by a digital platform for carrying out steps illustrated by the method of FIG. 14. It will be recalled that one of the steps of the method of FIG. 14 was a step for providing a tamper-resistant environment for carrying out specific defined steps. Thus part of the digital platform includes such a tamper-resistant environment. A person skilled in the arts will appreciate that the platform and included secure environment can take many forms, examples of which include a tamper-resistant card plugged into the slot of a standard PC desktop computer, a PC card implementing a tamper-resistant environment and plugged into a PC slot on a laptop computer, a hand-held device having a wireless network connection, processing means and a chip or chip set that implements a tamper-resistant environment, a wireless phone having a network connection and including a chip or chip set implementing a tamper-resistant environment, and in general any Internet ready or capable device that includes processing capability and a tamper-resistant environment. The specific steps illustrated in FIG. 14 will not be repeated here.

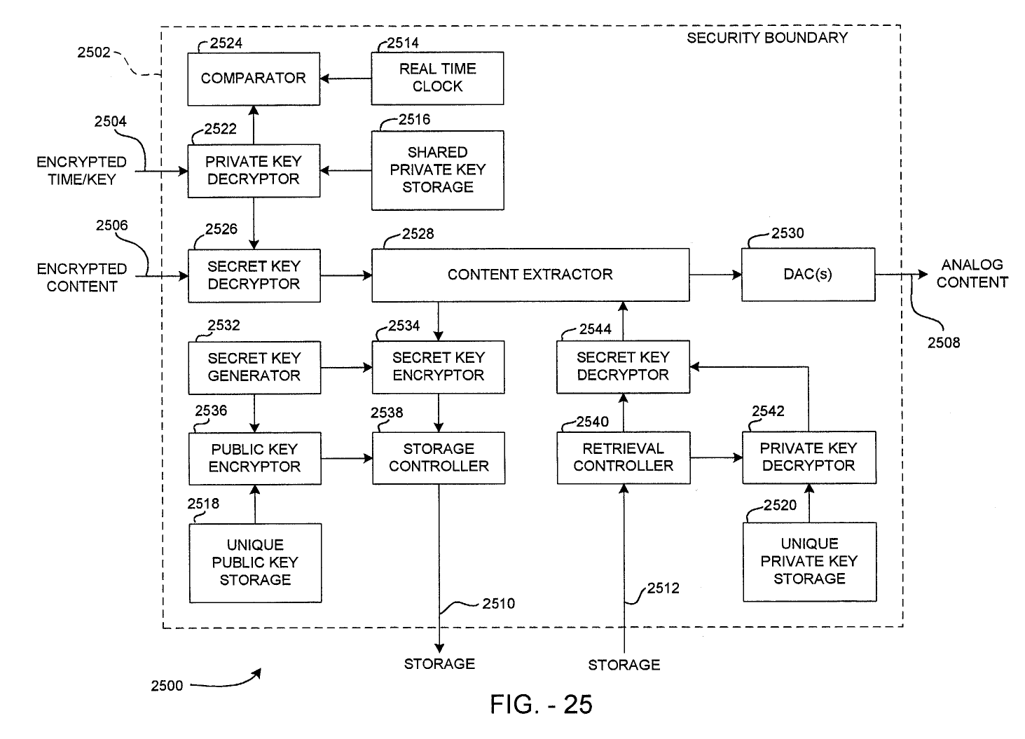

Another specific embodiment of the invention defines a combination of a computer program product such as described above and a tamper-resistant receiver sold for use with a digital platform. Examples include the desktop computer into which a tamper-resistant card is plugged into an internal computer slot and the method stored on the computer program product is read, loaded and executed, and the PC card implementation for plugging the tamper-resistant environment into a PC slot of a laptop computer. Such a combination is represented by the simple block diagram of FIG. 23. The useful combination is designated generally by the numeral 2300 and includes a combination 2302 of a computer program product 2304 and a tamper-resistant environment 2306, both for use with a compatible digital platform 2308 having a network connection 2310. It will be apparent to a person having an ordinary level of skill in the art that the network connection can also be made directly (not shown) with the tamper-resistant environment.

Another specific embodiment of the invention defines a computer program product useful with a transmitter for an encrypted digital content stream, such as the transmitters shown in FIGS. 6, 7, and 8, and used by the methods of FIGS. 19, 20, and 21.

FIG. 24 is a block diagram that illustrates a system for broadcasting an encrypted digital content stream via a communications network according to another aspect of the present invention. The system is designated generally by the reference numeral 2400 and includes digital content 2402 a broadcaster 2404, broadcast storage 2406, a communication network 2408, a tamper-resistant receiver 2410, analog content 2412, and receiver storage 2414. It will be appreciated by a person having an ordinary level of skill in the relevant arts that the communications network 2408 is not itself part of the invention, but the use of the communication network is part of the invention. The transmitter 2404 includes a connection for transmitting via the communication network, and the receiver 2410 includes a connection for receiving the transmission via the network 2408. The network is shown in FIG. 24 only for the purpose of illustrating the manner in which a digital content transmission is broadcast to the intended receiver(s).

FIG. 25 is a block diagram that illustrates another specific embodiment of a receiver according to another aspect of the present invention. The receiver is designated generally by the numeral 2500 and includes a security boundary 2502, an input line 2504 for receiving encrypted control information including a session key and a time code, another input line 2506 for receiving encrypted digital content, an output line 2508 for delivering analog content, control and output data lines 2510 for controlling and storing locally encrypted digital content on external storage (not shown), and control and input data lines 2512 for controlling and retrieving previously stored encrypted digital content. The receiver 2500 also includes a real time clock 2514, shared private key storage 2516, unique public key storage 2518, and unique private key storage 2520.

In one preferred embodiment, some or all of the keys (2516, 2518, 2520) and/or real time clock data 2514 are “zeroized” upon detection of an attempt to tamper with components within the receiver's security boundary 2502. This result may be accomplished, for example, via the means and methods used to implement the security boundary of IBM's 4758 PCI Cryptographic Co-processor (see U.S. Pat. No. 5,655,090, the full disclosure of which is incorporated herein by reference).

Multiple shared private keys are stored 2516 within the receiver 2500. These shared keys are useful, for example, when the first private key becomes compromised. Alternatively, these shared keys are used by multiple content distributors to distribute content.

Current inexpensive smart token devices capable of storing private keys in a tamper-resistant manner are available with 16 KBytes to 64 KBytes of non-volatile storage. When RSA is the public key algorithm used in the invention, strong private keys may be coded in as few as 128 bytes. In this case, from 128 to 512 private keys may be stored within such a smart token.

In a specific embodiment, a public key algorithm based on elliptic curve cryptography is used. In this embodiment, strong private keys may be coded in as little as one tenth of the storage required for RSA private keys. In this case, upward of 1,000 private keys may be stored within such a smart token. Additionally, the capacity of smart tokens is increasing as FLASH memory density increases, which is likely to continue its rapid pace. If, for example, smart tokens capable of storing 1 MByte of information are available within a few years, as is thought likely, such smart tokens will be capable of storing tens of thousands of private keys.

In another specific embodiment incorporating a transportable ‘smart token’, the token and the protected digital content are received and stored on removable media at a first receiver. The media is then removed from the first receiver and physically inserted into a second compatible receiver where it is played, as for example in a car stereo. The removable media includes, but is not limited to CD-ROM, floppy diskettes, removable hard drives such as the IBM MicroDrive®, flash memory cards and the like. A person having an ordinary level of skill in the art will appreciate that when the transportable smart token is removed from the first receiver, that receiver is no longer able to receive the digital content that it previously could receive.

In another specific embodiment of the receiver 2500, the encrypted control information 2504 is decrypted by private key decryptor 2522 using a shared private key obtained from the shared private key store 2516. The decrypted time code is compared by comparator 2524 with the output of the real time clock 2514 for enabling decryption, conversion and output of analog content 2508 (see the description with respect to FIGS. 11, 12, and 13). The decrypted session key (data key) is used by secret key decryptor 2526 to decrypt the encrypted content 2506 when enabled by comparator 2524.

A content extractor 2528 permits decrypted digital content to be re-encrypted locally and stored on external storage (not shown) for reuse. The content extractor 2528 also permits retrieved, previously stored locally encrypted and then locally re-decrypted digital content to be forwarded to digital-to-analog converter circuits 2530 for conversion to analog content for output 2508.

Local encryption of decrypted digital content for storage involves a secret key generator 2532, a secret key encryptor 2534, the unique public key store 2518, a public key encryptor 2536, and a storage controller 2538. In use, a secret key is generated 2532 and is used to encrypt 2534 the decrypted digital content. The now locally encrypted digital content is stored on the external store (not shown) under control of the storage controller 2538. A specific unique public key is selected from storage 2518 and is used to encrypt 2536 the secret key 2532 that was used to encrypt the digital content. The encrypted secret key 2536 is stored on the external store under control of the storage controller 2538. A clear “handle” (not shown) is stored on the external storage that identifies the specific unique public key that was used to encrypt the secret key.

The external storage now contains a clear handle, an encrypted copy of the secret key, and the re-encrypted digital content. To retrieve and use the stored data it is necessary to retrieve the clear handle, the encrypted secret key, use the handle to select a unique private key that will permit the encrypted secret key to be decrypted, and then use the decrypted secret key to decrypt the retrieved encrypted digital content. The retrieved clear handle is used to select a private key from the unique private key storage 2520. The selected private key corresponds to the unique public key 2518 that was used to encrypt the secret key 2532 used to encrypt the digital content. Retrieval is under the control of a retrieval controller 2540. The encrypted secret key is retrieved and is decrypted by a private key decryptor 2542 using the handle-selected unique private key 2520 which in turn is used by a secret key decryptor 2544 to decrypt the encrypted digital content as it is retrieved from the external store. The content extractor 2528 passes the decrypted digital content to the digital-to-analog converters 2530 for conversion to analog content 2508 for output.

While the invention has been described in relation to the embodiments shown in the accompanying drawing figures, other embodiments, alternatives and modifications will be apparent to those skilled in the art. It is intended that the specification be exemplary only, and that the true scope and spirit of the invention be indicated by the following claims.

What is claimed is:

1. A system for the secure distribution of digital content, comprising:
encrypted control information including a data key and a time code defining a window-of-opportunity;
an encrypted digital content stream; and
a tamper-resistant environment providing means for decrypting the encrypted control information, for using a secure local clock to verify the window-of-opportunity with the time code, and for using the decrypted data key to decrypt the encrypted digital content stream and convert the decrypted stream to an analog output stream,
whereby the encrypted digital content stream is convertible to an analog output stream only during the window-of-opportunity by a system having means for decrypting the encrypted control information and for verifying the window-of-opportunity.

2. The system as set forth in claim 1, wherein the tamper-resistant environment includes and protects the following:
(a) means for receiving the encrypted control information;
(b) a private key;
(c) means for using the private key to decrypt the received control information to obtain a clear version of the data key and the time code;
(d) a local clock providing a local real time;
(e) means for comparing the local real time with the received time code and for deciding whether the local real time is within the defined window-of-opportunity;
(f) means for receiving the encrypted digital content stream;
(g) means for decrypting the received digital content stream using the data key when the local real time is within the defined window-of-opportunity;
(h) means for converting the decrypted digital content stream to analog signals; and
(i) means for providing the analog signals outside the tamper-resistant environment.

3. The system as set forth in claim 2, further including:
(a) an unencrypted handle identifying a specific private key for decrypting the control information; and
(b) the tamper-resistant environment further including,
(1) private key storage and retrieval means,
(2) a plurality of private keys stored in the private key storage and retrieval means,
(3) means for receiving the unencrypted handle, and
(4) means for using the unencrypted handle to retrieve a specific private key from the storage and retrieval means for use in decrypting the received encrypted control information.

4. The system as set forth in claim 3, wherein the private key storage and retrieval means is implemented using non-volatile memory.

5. The system as set forth in claim 4, wherein the private keys are placed into the non-volatile memory by a trusted entity at time of manufacture of the tamper-resistant environment.

6. The system as set forth in claim 2, further including:
(a) the encrypted control information including a code specifying an algorithm for use in decrypting the encrypted digital content stream; and
(b) the tamper-resistant environment further including,
(1) means for using the private key to decrypt the algorithm specifying code, and
(2) the digital content stream decrypting means of the tamper-resistant environment further including,
(i) means for decrypting using a plurality of decryption algorithms, and
(ii) means for using the algorithm specifying code to select a decryption algorithm and decrypting the encrypted digital content stream using the selected algorithm.

7. The system as set forth in claim 2, wherein the encrypted control information defines a session establishment message

8. The system as set forth in claim 2, wherein the encrypted control information is included as a header preceding the encrypted digital content stream.

9. The system as set forth in claim 2, further including:
(a) local digital content stream storage and retrieval means; and
(b) the tamper-resistant environment further including,
(1) means for locally encrypting the decrypted digital content stream,
(2) means for storing the locally encrypted digital content stream on the local digital content stream storage and retrieval means,
(3) means for retrieving the encrypted digital content stream from the local digital content stream storage and retrieval means,
(4) means for decrypting the retrieved locally encrypted digital content stream, and
(5) means for connecting the decrypted digital content stream for analog output conversion.

10. The system as set forth in claim 2, further including means for distributing the encrypted control information.

11. The system as set forth in claim 10, further including means for distributing the encrypted digital content stream.

12. The system as set forth in claim 11, further including the means for distributing the encrypted digital content stream including means for distributing the encrypted control information.

13. The system as set forth in claim 10, further including means for distributing the encrypted digital content stream via a communications network.

14. The system as set forth in claim 13, wherein the communications network includes the Internet.

15. The system as set forth in claim 2, further including:
(1) means for distributing the encrypted digital content stream via a communications network; and
(2) wherein the encrypted control information is distributed via a trusted entity.

16. The system as set forth in claim 15, wherein the communications network includes the Internet.

17. The system as set forth in claim 15, wherein the means for distributing the encrypted digital content stream defines a transmitter including:
(1) means for receiving an unencrypted digital content stream;
(2) a copy of the data key; and
(3) means for encrypting the digital content stream using the data key.

18. The system as set forth in claim 17, wherein the defined transmitter further includes:
(1) data key storage and retrieval means;
(2) a plurality of data keys stored in the data key storage and retrieval means;
(3) means for selecting and retrieving a stored data key for use in encrypting the received digital content stream; and
(4) means for providing a copy of the selected data key to a trusted key distribution entity.

19. The system as set forth in claim 18, wherein the transmitter further includes the trusted key distribution entity for receiving the copy of the selected data key and for distributing an encrypted data key as part of encrypted control information.

20. The system as set forth in claim 17, further including transmitter digital content stream storage and retrieval means permitting the transmitter to store and retrieve a copy of the digital content stream, and means permitting the transmitter to use a retrieved copy of a digital content stream in the same manner as a received digital content stream.

21. The system as set forth in claim 2, wherein the time code defining a window of opportunity includes a start time and date, a stop time and date, and a maximum-allowable-clock-skew.

22. The system as set forth in claim 21, wherein the local clock is initialized to a universal real time at time of manufacture.

23. The system as set forth in claim 21, wherein the local clock has a predetermined maximum allowable time drift rate defined with respect to a trusted time standard.

24. The system as set forth in claim 22, wherein the means for comparing the local real time with the received time code for deciding whether the local real time is within the window of opportunity for enabling decryption of the received digital content stream insures that decryption is enabled only when local real time is within the window defined by the start time and date, and the stop time and date as adjusted for the maximum-allowable-clock-skew since initialization, and further wherein the universal real time defining both a time and date.

25. A method for securely distributing a digital content stream via a communications network, the method comprising the steps of:
(a) providing encrypted control information including a data key and a time code defining a window-of-opportunity;
(b) providing an encrypted digital content stream via a communications network;
(c) the data key being valid for decrypting the encrypted digital content stream during the window-of-opportunity;
(d) providing a tamper-resistant environment for carrying out the following steps, the tamper-resistant environment including a private key and a local clock providing a local real time,
(1) receiving the encrypted control information,
(2) using the private key to decrypt the received encrypted control information,
(3) comparing the local real time with the time code to determine whether the local real time is within the window-of-opportunity,
(4) receiving the encrypted digital content stream,
(5) enabling decryption of the received encrypted digital content stream by the data key when the local real time is within the window-of-opportunity,
(6) converting the decrypted digital content stream to analog signals, and
(7) providing the analog signals outside the tamper-resistant environment; and
(e) outputting the analog signals representing the digital content stream.

26. The method as set forth in claim 25, further including the steps of:
(a) providing an unencrypted handle identifying a specific private key for decrypting the encrypted control information;
(b) the provided tamper-resistant environment also including a plurality of private keys, including the specified private key, and private key storage and retrieval means for containing the private keys; and
(c) the following steps carried out within the tamper-resistant environment,
(1) receiving the unencrypted handle, and
(2) the using-the-private-key-to-decrypt step including the steps of
(i) using the unencrypted handle to select and retrieve a specific private key from the private key storage and retrieval means, and
(ii) using the selected and retrieved private key to decrypt the encrypted control information.

27. The method as set forth in claim 26, wherein the provided private key storage and retrieval means is implemented using non-volatile storage.

28. The method as set forth in claim 27, wherein the private keys are placed into the provided private key storage and retrieval means by a trusted entity.

29. The method as set forth in claim 25, wherein the provided encrypted control information includes a code identifying a specific encryption algorithm, and wherein the provided tamper-resistant environment includes means for decrypting the algorithm selection code and for using the data key and the selected algorithm for decrypting the received digital content stream, the method further including the steps of:
(a) using the private key to decrypt the algorithm selection code; and
(b) using the data key and the selected algorithm to decrypt the received encrypted digital content stream.

30. The method as set forth in claim 25, further including the steps of:
(a) providing the encrypted control information as a header preceding the encrypted digital content stream, and
(b) providing the combined stream and header via the communications network.

31. The method as set forth in claim 25, further including the steps of:
(a) providing local digital content stream storage and retrieval means;
(b) the provided tamper-resistant environment including means for re-encrypting and storing the decrypted digital content stream on the local digital content stream storage and retrieval means;
(c) the provided tamper-resistant environment including means for retrieving and decrypting the stored digital content stream from the local digital content stream storage and retrieval means;
(d) the provided tamper-resistant environment including means for converting the retrieved and decrypted digital content stream to analog signals for output;
(e) re-encrypting the decrypted digital content stream and storing the result on the local digital content stream storage and retrieval means; and
(f) retrieving, decrypting, and converting to analog signals a previously stored digital content stream.

32. The method as set forth in claim 25, wherein the communications network is the Internet.

33. The method as set forth in claim 25, wherein the providing encrypted control information step is carried out by a trusted entity.

34. The method as set forth in claim 25, wherein the providing an encrypted digital content stream step further includes the steps of:
(a) providing a transmitter having a communication network connection for transmitting the encrypted digital content stream;
(b) the provided transmitter further including means for receiving an unencrypted digital content stream, a copy of the data key, and means for encrypting the received unencrypted digital content stream using the data key; and
(c) the transmitter receiving the unencrypted digital content stream, encrypting the received stream using the copy of the data key, and transmitting the encrypted digital content stream via the communication network connection.

35. The method as set forth in claim 34, further including the steps of:
(a) the provided transmitter further including,
(1) data key storage and retrieval means,
(2) a plurality of data keys stored in the data key storage and retrieval means,
(3) means for selecting and retrieving a stored data key for use in encrypting the received digital content stream, and
(4) means for providing a copy of the selected data key to a trusted key distribution entity;
(b) selecting and retrieving a stored data key from the data key storage and retrieval means;
(c) using the selected data key to encrypt the received unencrypted digital content stream;
(d) transmitting the encrypted digital content stream via the network connection; and
(e) providing a copy of the selected data key to a trusted key distribution entity.

36. The method as set forth in claim 35, further including the steps of:
(a) the provided transmitter further including the trusted key distribution entity; and
(b) distributing an encrypted data key as part of the encrypted control information.

37. The method as set forth in claim 34, further including the steps of:
(a) the provided transmitter further including digital content stream storage and retrieval means;
(b) storing the received unencrypted digital content stream for later use;
(c) retrieving a previously stored unencrypted digital content stream; and
(d) using the retrieved stream in the same manner as a received stream.

38. The method as set forth in claim 25, wherein the step of providing an encrypted time code defining a window-of-opportunity further includes the steps of:
(a) providing a start time and date, a stop time and date, and a maximum-allowable-clock-skew;
(b) the start time and date defining a time following which a provided data key is valid for decrypting the received encrypted digital content stream;
(c) the stop time and date defining a time following which the provided data key is no longer valid for decrypting the received encrypted digital content stream; and
(d) the maximum-allowable-clock-skew defining a margin-of-error between the provided start and stop times and the local real time.

39. The method as set forth in claim 38, wherein the step of comparing the local real time with the time code further includes the steps of:
(a) extending a leading edge of the window-of-opportunity by comparing the local real time with the difference of the start time and the maximum-allowable-clock-skew;
(b) extending the trailing edge of the window-of-opportunity by comparing the local real time with the sum of the stop time and the maximum-allowable-clock-skew; and
(c) determining whether the local real time is within the extended window-of-opportunity.

40. A computer program product storing a method executable by a digital platform for carrying out the following steps:
(a) providing encrypted control information including a data key and a time code defining a window-of-opportunity;
(b) providing an encrypted digital content stream via a communications network;
(c) the data key being valid for decrypting the encrypted digital content stream during the window-of-opportunity;
(d) providing a tamper-resistant environment for carrying out the following steps, the tamper-resistant environment including a private key and a local clock providing a local real time,
(1) receiving the encrypted control information,
(2) using the private key to decrypt the received encrypted control information,
(3) comparing the local real time with the time code to determine whether the local real time is within the window-of-opportunity,
(4) receiving the encrypted digital content stream,
(5) enabling decryption of the received encrypted digital content stream by the data key when the local real time is within the window-of-opportunity,
(6) converting the decrypted digital content stream to analog signals, and
(7) providing the analog signals outside the tamper-resistant environment; and
(e) outputting the analog signals representing the digital content stream.

41. A combination of a computer program product and a tamper-resistant environment defining a receiver for use with a personal computer, comprising:
(a) a computer program product as defined by claim 40; and
(b) a tamper-resistant receiver for use with a digital platform having a network connection, as defined by claim 5.

42. A computer program product storing a method executable by a digital platform having a network connection and defining a transmitter as set forth in claim 19, the method defining the steps of:
(a) receiving the unencrypted digital content stream;
(b) selecting a data key;
(c) encrypting a copy of the selected data key;
(d) distributing via network connection the encrypted control information including the selected data key and the defined window-of-opportunity;
(e) using the selected data key to encrypt the received unencrypted digital content stream; and
(f) distributing via the network connection the encrypted digital control stream.
